(19) United States
(12) Patent Application Publication
(10) Pub. No.: US 2021/0166390 A1
(43) Pub. Date: Jun. 3, 2021

(54) METHOD, APPARATUS AND STORAGE MEDIUM FOR ANALYZING INSECT FEEDING BEHAVIOR

(71) Applicants: South China Normal University, Guangzhou City (CN); Guangmeiyuan R & D Center, Key Laboratory of Insect Developmental Biology and Applied Technology, So, Meizhou City (CN)

(72) Inventors: Na LI, Meizhou City (CN); Sheng LI, Meizhou City (CN)

(73) Assignees: South China Normal University, Guangzhou City (CN); Guangmeiyuan R & D Center, Key Laboratory of Insect Developmental Biology and Applied Technology, So, Meizhou City (CN)

(21) Appl. No.: 16/794,897

(22) Filed: Feb. 19, 2020

(30) Foreign Application Priority Data
Nov. 28, 2019 (CN) 201911188827.9

(51) Int. Cl. G06T 7/00; G06T 7/246; G06T 7/277; G06T 7/11; G06T 7/187; G06T 7/73; G06N 3/08; G06N 20/00

(52) U.S. Cl. CPC G06T 7/0016; G06T 7/248; G06T 7/277; G06T 7/11; G06T 7/187; G06T 7/74; G06T 2207/10016; G06N 20/00; G06T 2207/30241; G06T 2207/20084; G06T 2207/20081; G06T 2207/20021; G06N 3/08

(57) ABSTRACT

A method, apparatus and storage medium for analyzing insect feeding behaviors are disclosed. The method comprises detecting insects in a video recording feeding activities of the insects by deep learning using a neural network to obtain a detection result, obtaining insect trajectories according to the detection result, and obtaining an analysis result according to the insect trajectories. According to the present disclosure, the detection and analysis are performed on a pre-recorded video by deep learning using a neural network, and then the insect trajectories and an analysis result are obtained according to the detection result, thus manual observation, recording and analysis are not needed, the efficiency is high. Besides, subjective assumptions are eliminated for higher accuracy. The present disclosure, as a method, apparatus and storage medium for analyzing insect feeding behaviors, can be widely used in the field of insect behavior analysis.

### TECHNICAL FIELD

The present disclosure relates to the field of insect behavior analysis technologies, and in particular, to a method, apparatus and storage medium for analyzing insect feeding behaviors.

### BACKGROUND

Entomology is a science that studies behavior types, patterns and generation mechanisms of insects, which is an indispensable part of entomological research. Through insect behaviors, intricate backgrounds and mechanisms behind the behaviors can be analyzed, and then obtained analysis results can be used to prevent pests or kill insects.

The behavior patterns of insects mainly include feeding behaviors, reproduction behaviors, orientation and movement behaviors, and communication behaviors and so on. However, today's analysis of insect feeding behaviors is based on manual close and direct observation, manual recording and analysis, which is labor-intensive, subjective, inefficient and inaccurate. In addition, when an insect is of a small size, it is difficult to observe by naked eyes.

### SUMMARY

In view of the above, in order to solve the above technical problems, the present disclosure aims at providing a method, apparatus and storage medium for analyzing insect feeding behaviors.

A method for analyzing insect feeding behaviors of the present disclosure, comprising the steps of:

detecting insects in a video recording feeding activities of the insects by deep learning using a neural network, to obtain a detection result;

obtaining insect trajectories according to the detection result; and

obtaining an analysis result according to the insect trajectories.

Further, the video comprises multiple frames of images, and the step of detecting insects in a video by deep learning using a neural network comprises:

labeling the insects in images by using a ground truth box; and

inputting the labeled images into the neural network for deep learning, and obtaining the detection result according to a preset threshold.

Further, the step of inputting the labeled images into the neural network for deep learning, and obtaining a detection result according to a preset threshold comprises:
dividing labeled images into multiple grids through the neural network;
obtaining prediction information by deep learning according to a relationship between a center position of the ground truth box and the position of the grids; and
obtaining the detection result according to the preset threshold and a confidence score.

The prediction information comprises multiple pieces of bounding box information and corresponding confidence scores predicted by each grid and class information predicted by each grid, and the bounding box information comprises an offset of the center position of the ground truth box relative to the position of the grids, a width and a height of the ground truth box.

The detection result comprises at least part of the prediction information.

Further, the step of obtaining the detection result according to the preset threshold and a confidence score comprises:
filtering the bounding box information of which the confidence score is less than the preset threshold; and
processing the bounding box information retained after filtering by non-maximum suppression to obtain the detection result.

Further, the step of obtaining insect trajectories according to the detection result comprises:
processing the detection result by Kalman filtering to obtain a predicted value of an insect position; and
obtaining the insect trajectories according to the predicted value,

The detection result comprises a position of an insect centroid in a first-frame image, the predicted value comprises a predicted position of the insect centroid in the first-frame image, and the video comprises multiple frames of images.

Further, the step of obtaining the insect trajectories according to the predicted value comprises:
obtaining a Euclidean distance between a position of an insect centroid in a second-frame image and the predicted value according to the predicted value and the position of the insect centroid in the second-frame image; and
determining a trajectory of each insect by using a Hungarian algorithm according to the Euclidean distance,

The detection result comprises the position of the insect centroid in the second-frame image, and the second frame is larger than the first frame.

Further, the step of obtaining an analysis result according to the insect trajectories comprises:
obtaining a trajectory chart of insect paths, and/or frequencies of the paths, and/or aggregation of insects when feeding according to the insect trajectories.

The present disclosure further provides an apparatus for analyzing insect feeding behaviors, comprising:
a detection module for detecting insects in a video recording feeding activities of the insects by deep learning using a neural network, to obtain a detection result;
a tracking module for obtaining insect trajectories according to the detection result; and
an analysis module for obtaining an analysis result according to the insect trajectories.

The present disclosure further provides an apparatus for analyzing insect feeding behaviors, comprising:
at least one processor; and
at least one memory for storing at least one program,
wherein, when the at least one program is executed by the at least one processor, the at least one processor is caused to perform the method for analyzing insect feeding behaviors.

The present disclosure further provides a storage medium storing processor executable instructions, wherein, when loaded and executed by a processor, causing the processor to perform the method for analyzing insect feeding behaviors.

The present disclosure has the following beneficial effects: insects in a video are detected by deep learning using a neural network, insect trajectories are obtained according to a detection result obtained, and an analysis result is obtained according to the insect trajectories. According to the present disclosure, the detection and analysis are performed on a pre-recorded video by deep learning using a neural network, and then the insect trajectories and the analysis result are obtained according to the detection result obtained. Thus, manual observation, recording and analysis are not needed, and the efficiency is high. Besides, subjective assumptions are eliminated, and the accuracy is obviously high.

### BRIEF DESCRIPTION OF THE DRAWINGS

FIG. 1 is a schematic flowchart of steps of a method according to the present disclosure; and

FIG. 2 is a schematic flowchart of data processing according to a specific embodiment of the present disclosure.

### DETAILED DESCRIPTION

The present disclosure will be further explained and described as below with reference to the accompanying drawings and specific embodiments of the specification. Serial numbers of steps in embodiments of the present disclosure are provided only for the convenience of illustration, without any limitations to the order between the steps, and the order of execution of the steps in the embodiments can be adjusted adaptively according to the understanding of a person skilled in the art.

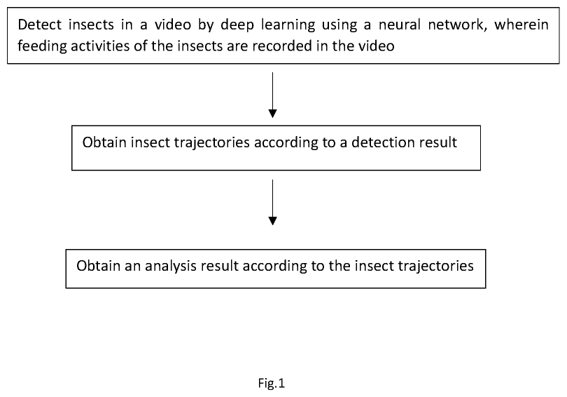

As shown in FIG. 1, a method for analyzing insect feeding behaviors in this embodiment includes steps of:

detecting insects in a video recording feeding activities of the insects by deep learning using a neural network, to obtain a detection result;

obtaining insect trajectories according to the detection result; and

obtaining an analysis result according to the insect trajectories. In this embodiment, the following steps are specifically included.

1) Provision of a Feeding Apparatus

In this embodiment, the feeding apparatus includes an infrared lamp board and a feeding tray. The insects are cockroaches, which in other embodiments can be parasitic wasps, thrips, locusts, butterflies, bees, dragonflies, grasshoppers and other insects. A plurality of cockroaches are placed in the feeding tray, which is square in shape. Fan-shaped feeding areas are disposed at the four corners of the square, and food is placed in each fan-shaped feeding area. The infrared lamp board is disposed below the feeding tray to provide infrared lighting for a camera system. The reason for the use of infrared lighting is that the cockroaches are not sensitive to infrared light and their behaviors will not be affected. In other embodiments, other kinds of light sources can be used according to the species of the insects observed.

2) Provision of a Camera System

In this embodiment, the camera system is composed of a high-definition camera and an industrial computer. The high-definition camera is positioned above the feeding tray to capture videos of activities of multiple cockroaches throughout the feeding tray area, including feeding states. The industrial computer is connected to the high-definition camera and serves as a data storage and processing center, and is provided with a variety of algorithms and analysis tools for storing and analyzing the captured video. In this embodiment, a video captured in advance is used for processing and analysis, while in other embodiments, a real-time video can be acquired and insects in the real-time video are detected and analyzed directly by deep learning using a neural network.

3) Pre-Processing of Video

Preprocessing a video mainly includes two steps. First, a required video is clipped to obtain a target area of an appropriate size, such as a certain period of time or when the cockroach starts to be active. Then, Gaussian filtering is conducted on the video to remove random noise for further data processing.

4) Detection of Insects in the Video by Deep Learning Using a Neural Network

1. Data labeling: a video has multiple frames each of which is regarded as an image, and multiple images, preferably images representing the movement of the cockroaches, are obtained from the preprocessed video. Multiple cockroaches in the images are labeled with a ground truth box of which the outline is the same or similar to that of the cockroaches, or with a rectangular box that is similar in size to the cockroaches.

2. Detection: training is performed using the GPU (NVidia@ graphics card, used for intelligent computing) of the industrial computer to obtain network parameters which are used for cockroach detection.

In this embodiment, the neural network is Yolo-V3, and the labeled image is wholly input into the neural network which divides the image into S×S grids. If coordinates of a center position (centroid) of a ground truth box of a cockroach fall into a certain grid, the grid is responsible for detecting the cockroach. Through deep learning, each grid obtains prediction information by prediction, including B bounding boxes which are used to predict bounding box information, corresponding confidence scores, and C class probabilities. The sizes of S, B and C can be customized as required.

The bounding box information includes (x, y), w, h, which respectively represent offset coordinates of the center position of the cockroach (i.e., the ground truth box) relative to the position of the grid, width and height of the cockroach, and are all normalized. The confidence score is Pr(Object)×IOUtruthpred, where Pr(Object) ∈ {0,1}, and when a cockroach falls in a grid, the Pr(Object) of the grid is 1, otherwise 0. IOUtruthpred is an IoU value (Intersection-over-Union) between the predicted bounding box and the actual ground truth box. The confidence score represents both the truth degree of the predicting bounding box containing cockroaches and the accuracy of prediction of the bounding box, reflecting whether cockroaches are contained and the accuracy of the position when the cockroaches are contained. Each bounding box should predict a total of 5 values of the bounding box information and confidence scores, and each grid should also predict one piece of class information, denoted as class C; therefore, a vector of S×S×(5×B+C) finally output by a deep learning network can represent the position of the bounding box and the class to which it belongs. In this embodiment, there is only one kind of insect, so C=1.

Through a preset threshold, the bounding box information of which the confidence score is less than the threshold is filtered out, and then the bounding box information retained after filtering is processed by non-maximum suppression (NMS) to obtain the detection result (including at least part of the prediction information, among which the class information is not filtered, only overlapping bounding boxes are filtered out, and if multiple results overlap, they are merged into one). The detection result is a result of the detection on multiple cockroaches, that is, multiple cockroaches are detected in each frame of image and labeled with bounding boxes, and each bounding box has a centroid (equivalent to the position of an insect centroid).

In this embodiment, a single neural network is applied to the whole image, so global information in the image is used during the prediction. That is, unlike R-CNN which requires thousands of single target images, prediction is performed through single network assessment in this scheme, thus making the processing speed of Yolo-V3 fast, which is also suitable for real-time processing and cockroach real-time monitoring in addition to offline data processing.

5) Processing of Detection Result by Kalman Filtering

In this embodiment, in an actual situation, there will be noise, errors and omission in the detection, so it is necessary to eliminate the above influences by discrete Kalman filtering. Specifically, a first-frame image in the detection result is processed by discrete Kalman filtering to obtain a predicted position of an insect centroid in the first-frame image, namely, a predicted value (or a predicted result) \hat{X}(k). The first frame refers to one of the multiple frames in the video, just for the convenience of explanation, and is not limited to the first frame in the video.

A state equation, a measurement equation and a state prediction equation of the discrete Kalman filtering are as follows.

The position of the cockroach X(k) is estimated according to its previous position X(k−1), firstly:

an estimated state equation:

\hat{X}(k)=j(k)X(k−1)+G(k)w(k)

Since the predicted value \hat{X}(k) is not necessarily accurate, \hat{X}(k) needs to be modified with additional information, such as an observed value Z(k), which refers to the above detection result of each frame of image.

The measurement equation:

Z(k)=H(k)\hat{X}(k)+v(k)

In the above two equations, k represents the time (frame), \hat{X}(k) represents the predicted position of the cockroach at the time k, j (k) is a state transfer matrix of the position, G(k) is a state transfer matrix of the noise, which describes the impact of specific noise on the position of the cockroach, w(k) is a noise matrix, Z(k) is a detection result at the time k, H(k) is a measurement transfer matrix, and v(k) is the measurement noise.

The state prediction equation:

X(k)=\hat{X}(k)+k(k)[Z(k)−H(k)\hat{X}(k)]

where k(k) is a Kalman gain, whose main function is to adjust the weight of \hat{X}(k) and Z(k), and if a small value is assigned, the system trusts the predicted result more, while if a large value is assigned, the system trusts the detection result more, and the value is updated every time in this embodiment; X(k) is the best prediction result of the position of the cockroach at the time k.

In the Kalman filtering process, the initial state needs to be initialized, and then every time there is a new measurement, the Kalman filtering is started, and the cycle continues until there is no new measurement. In this embodiment, the measurement is the detection result and represents the position of the cockroach detected each time.

6) Data Processing by Using a Hungarian Algorithm

In this embodiment, multi-view tracking is involved since there are multiple cockroaches. In the previous step, multiple cockroaches labeled in a certain frame of image are obtained, and multiple cockroaches labeled in the frame of image are also obtained in the next frame of image. Therefore, the cockroaches in the two frames of images should be matched correspondingly to obtain different cockroach trajectories corresponding to the multiple cockroaches.

For example, the best prediction result (or tracking result) at the time k−1 is X(k−1)={X1,X2 . . . Xn}, where Xn represents an element contained in the best detection result, and n is the number of cockroaches. According to the moving speed of the cockroaches, the position of the cockroaches at the time k can be estimated. Therefore, the predicted value \hat{X}n corresponding to each element can be obtained by predicting each element Xn in X(k−1). So a prediction result at the time k is \hat{X}(k)={\hat{X}1, \hat{X}2, . . . \hat{X}n}. A detection result at the time k is Z(k), but the detection results does not include serial number information of the cockroaches, that is, it is not known which cockroach the detected result belongs to. Therefore, a corresponding relationship between elements in \hat{X}(k) and Z(k) can be regarded as an assignment problem. The Euclidean distance between the elements is taken as a “cost” to form a cost matrix, and an assignment result is determined using the Hungarian algorithm.

In this embodiment, the cockroaches are paired using the Hungarian algorithm (Hungarian algorithm matching algorithm). The Hungarian matching algorithm is an algorithm that uses an augmenting path to obtain the maximum matching of a bipartite graph, which is composed of width first search (BFS), such as the Euclidean distance in this embodiment.

The augmenting path is an alternate path from an unmatched point. This alternate path is called an augmenting path if it passes through another unmatched point (the starting point does not count). The alternate path refers to starting from an unmatched point and passing through an unmatched edge, a matched edge, an unmatched edge . . . , and the path formed so is called an alternate path.

Specifically, a position of a cockroach centroid in a second-frame image included in the detection result is acquired, wherein the second frame refers to a frame after the first frame in time, just for the convenience of description, and is not limited to the second frame in the video. Preferably, the second frame is adjacent to the first frame. A Euclidean distance between the position of the cockroach centroid in the second-frame image and the predicted value is calculated according to the predicted value (the predicted position of the cockroach centroid in the first-frame image) and the position of the cockroach centroid in the second-frame image (detection result). Since there are multiple Euclidean distances, priority matching of the augmenting path is performed according to the minimized Euclidean distance, and the points on the path (tracking results) are recorded through a prey array. Finally, the track of each cockroach is obtained according to multiple tracking results.

When a cockroach in the second-frame image is located in the feeding area and blocked so that the cockroach cannot be detected in the second-frame image, the predicted value of the cockroach in the first-frame image processed by Kalman filtering can be automatically used to replace the final tracking result of the cockroach.

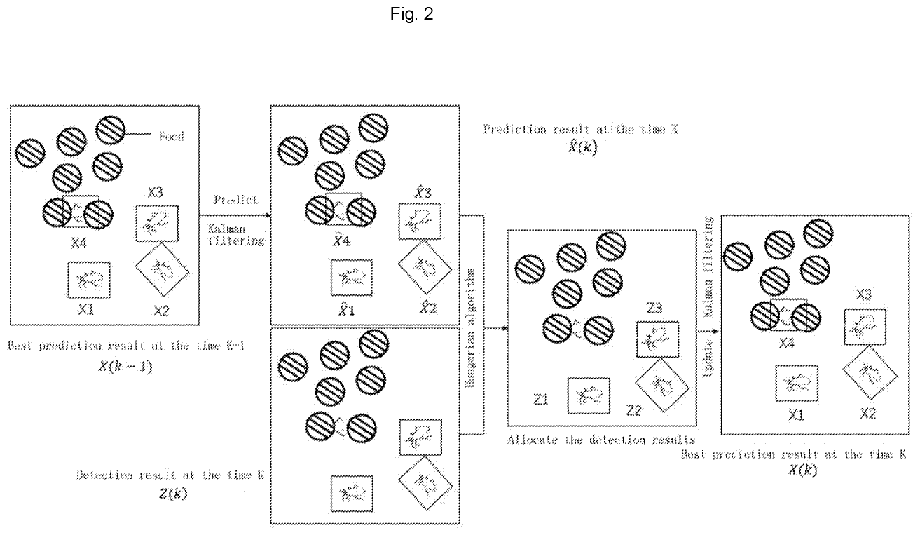

FIG. 2 shows a processing process of Kalman filtering and the Hungarian algorithm Z(k)={Z1, Z2, . . . Zn}, where Zn represents an element included after the detection result is allocated.

7) Adjustment of Loss

The position of the tracking result of each cockroach in the next-frame image is calculated and predicted by Kalman filtering, then the Euclidean distance (between the centroids) between the predicted position and the corresponding cockroach in the actual detection result is calculated, and the calculated measurement result is adjusted as a loss function matrix. The size of the loss matrix is (M, N), where M is the number of trajectories and N is the number of moving objects detected.

8) Obtaining of an Analysis Result According to the Cockroach Trajectory

1. Obtaining of a trajectory chart: by using the coordinates set in the image, a coordinate is labeled when the cockroach passes it to obtain a trajectory chart recording the position passed by each cockroach.

2. Obtaining of a thermodynamic chart: a thermal counter is disposed for each coordinate in the image coordinate system. If a cockroach passes through the coordinate, the thermal counter of the coordinate will be increased by 1. After summation of the results of all frames of the video, the frequency at which the cockroach passes through each coordinate will be obtained.

3. Obtaining of aggregation: the number of cockroaches in the four feeding areas is counted in real time to obtain aggregation of the cockroaches in the feeding areas.

4. Obtaining of basic parameters: the speed, distance and other parameters of the cockroach are calculated.

After the above analysis result is obtained, it can be applied in practice. For example, according to the trajectory chart and the thermodynamic chart, insecticides are placed at a position on a path which is passed by the cockroach most frequently to improve the insecticidal effect. The insecticides are distributed in different regions according to aggregation to improve insecticidal efficiency and so on.

The present disclosure further provides an apparatus for analyzing insect feeding behaviors, including:

a detection module for detecting insects in a video by deep learning using a neural network to obtain a detection result, wherein feeding activities of a plurality of insects are recorded in the video;

a tracking module for obtaining insect trajectories according to the detection result; and

an analysis module for obtaining an analysis result according to the insect trajectories.

The embodiments of the present disclosure further provide an apparatus for analyzing insect feeding behaviors, including:

at least one processor; and

at least one memory for storing at least one program,

wherein when the at least one program is executed by the at least one processor, the at least one processor is caused to perform the method for analyzing insect feeding behaviors.

The contents of the above method embodiment are applicable to the system embodiment, the functions specifically implemented by the system embodiment are the same as those implemented by the above method embodiment, and the beneficial effects achieved are the same as those achieved by the above method embodiment.

In conclusion, compared with the prior art, the present disclosure has the following advantages:

1) On a pre-recorded video, detection and analysis is conducted by deep learning using a neural network, and then the insect trajectories and an analysis result are obtained according to the detection result, thus manual observation, recording and analysis are not needed, and the efficiency is high. In addition, subjective assumptions are eliminated, and the accuracy improved significantly

2) Even if the cockroach is located in the feeding area and blocked, the cockroach will still be detected by Kalman filtering to prevent the problem of missing detection, the detection is highly accurate.

3) The trajectories of the cockroaches can be obtained accurately by Kalman filtering in combination with the Hungarian algorithm, which is more efficient and accurate than manual recording.

4) The analysis result can be obtained quickly and accurately by using the trajectories of the cockroaches in combination with statistical analysis tools of the industrial computer, and the efficiency is extremely high.

In some optional embodiments, the functions/operations mentioned in the block diagram may not occur in the order mentioned in the diagram of operations. For example, depending on the functions/operations involved, the two blocks shown consecutively can actually be executed at roughly the same time or the blocks can sometimes be executed in reverse order. In addition, embodiments presented and described in the flowchart of the present disclosure are provided in the form of examples for the purpose of providing a more complete understanding of the technology. The method disclosed is not limited to the operations and logical processes presented in this text. The optional embodiments are predictable in which the sequence of operations is changed and the sub-operations described as a part of a larger operation are executed independently.

Furthermore, although the present disclosure is described under the background of functional modules and is illustrated in the form of block diagrams, but it should be understood that unless otherwise described, one or more of the functions and/or features can be integrated in a single physical device and/or software module, or one or more of the functions and/or features can be implemented in a separate physical device or software module. It should be further understood that a detailed discussion of the actual implementation of each module is not necessary to understand the present disclosure. Rather, in consideration of the properties, functions, and internal relationships of various functional modules in the apparatus disclosed in this test, the actual implementation of the module will be known in the engineer's normal technique. Therefore, a person skilled in the art can implement the present disclosure as stated in the claims using ordinary technologies without excessive testing. It should also be understood that the specific concept disclosed is merely illustrative and is not intended to limit the scope of the present disclosure, which is determined by the full scope of the attached claims and its equivalent schemes.

The embodiments of the present disclosure further provide a storage medium storing processor executable instructions, wherein the processor performs the method for analyzing insect feeding behaviors when executing the processor executable instructions.

Similarly, it can be seen that the contents of the above method embodiment are applicable to the storage medium embodiment, and the functions and beneficial effects achieved are the same as those achieved by the method embodiment.

When the integrated unit is implemented in the form of a software functional unit and sold or used as an independent product, the integrated unit may be stored in a computer-readable storage medium. Based on such understanding, the technical solutions of the present disclosure essentially, or the part that makes contributions to the prior art, or all or a part of the technical solutions may be implemented in a form of a software product. The computer software product is stored in a storage medium, and includes several instructions for instructing a computer device (which may be a personal computer, a server, or a network device) to perform all or a part of the steps of the methods described in the embodiments of the present disclosure. The above storage medium includes: any medium that can store a program code, such as a USB flash drive, a removable hard disk, a Read-Only Memory (ROM), a Random Access Memory (RAM), a magnetic disk, or an optical disc.

The logic and/or steps indicated in the flowchart or described here in other manners, for example, a sequence list of executable instructions that can be considered to be used to implement logic functions, can be specifically implemented in any computer readable medium, for use by an instruction executing system, apparatus or device (such as a computer-based system, a system including a processor or other systems that can fetch instructions from the instruction executing system, apparatus or device and execute the instructions), or used in combination with the instruction executing system, apparatus or device. In terms of the specification, the “computer readable medium” may be any apparatus that may contain, store, communicate, propagate or transmit programs for use by an instruction executing system, apparatus or device or to be used in combination with the instruction executing system, apparatus or device.

More specific examples (non-exhaustive list) of the computer readable medium include the following: an electric connection part (electronic apparatus) having one or more wires, a portable computer enclosure (magnetic apparatus), a random access memory (RAM), a read-only memory (ROM), an erasable editable read-only memory (EPROM or flash memory), an optical fibre apparatus, and a portable compact disk read-only memory (CDROM). In addition, the computer readable medium can even be paper on which the programs can be printed or other suitable media, because the programs can be obtained electronically, for example, by optically scanning the paper or other media and then editing, interpreting or processing in other suitable manners if necessary, and then the programs are stored in the computer memory.

In the descriptions of the specification, the descriptions about the reference terms “an embodiment,” “some embodiments,” “an example,” “a specific example,” “some examples” and the like mean that specific features, structures, materials or characteristics described in combination with the embodiment(s) or example(s) are included in at least one embodiment or example of the present disclosure. In the specification, schematic expressions of the above terms do not necessarily refer to the same embodiment or example. Moreover, the specific features, structures, materials or characteristics described may be combined in a suitable manner in any one or more embodiments or examples.

Preferred embodiments of the present disclosure are specifically described above, but the present disclosure is not limited to the embodiments. A person skilled in the art can also make various equivalent transformations or replacements without departing from the spirit of the present disclosure. These equivalent transformations or replacements are all encompassed in the scope defined by the claims of the application.

1. A method for analyzing insect feeding behaviors, comprising steps of:
obtaining a video recording feeding activities of a plurality of insets;
detecting the insects in the video by deep learning using a neural network, to obtain a detection result;
obtaining trajectories of the insects according to the detection result; and
obtaining an analysis result according to the trajectories of the insects.

2. The method for analyzing insect feeding behaviors according to claim 1, wherein the video comprises multiple frames of image, and the step of detecting insects in the video by deep learning using a neural network comprises:
labeling the insects by using a ground truth box in images; and
inputting the labeled images into the neural network for deep learning, and obtaining a detection result according to a preset threshold.

3. The method for analyzing insect feeding behaviors according to claim 2, wherein the step of inputting the labeled images into the neural network for deep learning, and obtaining a detection result according to a preset threshold comprises:
dividing the labeled images into multiple grids through the neural network;
obtaining prediction information by deep learning according to a relationship between the center position of the ground truth box and the position of the grids; and
obtaining the detection result according to the preset threshold and a confidence score,
wherein, the prediction information comprises multiple pieces of bounding box information and corresponding confidence scores predicted by each grid and class information predicted by each grid, and the bounding box information comprises an offset of the center position of the ground truth box relative to the position of the grids, a width and a height of the ground truth box; and
the detection result comprises at least part of the prediction information.

4. The method for analyzing insect feeding behaviors according to claim 3, wherein the step of obtaining the detection result according to the preset threshold and a confidence score comprises:
filtering the bounding box information of which the confidence score is less than the preset threshold; and
processing the bounding box information retained after filtering, by non-maximum suppression, to obtain the detection result.

5. The method for analyzing insect feeding behaviors according to claim 1, wherein the step of obtaining insect trajectories according to a detection result comprises:
processing the detection result by Kalman filtering to obtain a predicted value of an insect position; and
obtaining the insect trajectory according to the predicted value,
wherein, the detection result comprises a position of an insect centroid in a first-frame image, the predicted value comprises a predicted position of the insect centroid in the first-frame image, and the video comprises multiple frames of images.

6. The method for analyzing insect feeding behaviors according to claim 5, wherein the step of obtaining the insect trajectories according to the predicted value comprises:
obtaining a Euclidean distance between a position of an insect centroid in a second-frame image and the predicted value, according to the predicted value and the position of the insect centroid in the second-frame image; and
determining a trajectory of each of the insects by using a Hungarian algorithm according to the Euclidean distance,
wherein, the detection result comprises the position of the insect centroid in the second-frame image, and the second frame is larger than the first frame.

7. The method for analyzing insect feeding behaviors according to claim 1, wherein the step of obtaining an analysis result according to the insect trajectories comprises:
obtaining a trajectory chart of insect paths, and/or frequencies of the paths, and/or aggregations of insects when feeding, according to the insect trajectories.

8. An apparatus for analyzing insect feeding behaviors, comprising:
at least one processor; and
at least one memory for storing at least one program,
wherein when the at least one program is executed by the at least one processor, the at least one processor is caused to perform a method for analyzing insect feeding behaviors, the method comprising:
obtaining a video recording feeding activities of a plurality of insets;
detecting the insects in the video by deep learning using a neural network, to obtain a detection result;
obtaining trajectories of the insects according to the detection result; and
obtaining an analysis result according to the trajectories of the insects.

9. The apparatus for analyzing insect feeding behaviors according to claim 8, wherein the video comprises multiple frames of image, and the step of detecting insects in the video by deep learning using a neural network comprises:
labeling the insects by using a ground truth box in images; and
inputting the labeled images into the neural network for deep learning, and obtaining a detection result according to a preset threshold.

10. The apparatus for analyzing insect feeding behaviors according to claim 9, wherein the step of inputting the labeled images into the neural network for deep learning, and obtaining a detection result according to a preset threshold comprises:
dividing the labeled images into multiple grids through the neural network;
obtaining prediction information by deep learning according to a relationship between the center position of the ground truth box and the position of the grids; and
obtaining the detection result according to the preset threshold and a confidence score,
wherein, the prediction information comprises multiple pieces of bounding box information and corresponding confidence scores predicted by each grid and class information predicted by each grid, and the bounding box information comprises an offset of the center position of the ground truth box relative to the position of the grids, a width and a height of the ground truth box; and
the detection result comprises at least part of the prediction information.

11. The apparatus for analyzing insect feeding behaviors according to claim 10, wherein the step of obtaining the detection result according to the preset threshold and a confidence score comprises:
filtering the bounding box information of which the confidence score is less than the preset threshold; and
processing the bounding box information retained after filtering, by non-maximum suppression, to obtain the detection result.

12. The apparatus for analyzing insect feeding behaviors according to claim 8, wherein the step of obtaining insect trajectories according to a detection result comprises:
processing the detection result by Kalman filtering to obtain a predicted value of an insect position; and
obtaining the insect trajectory according to the predicted value,
wherein, the detection result comprises a position of an insect centroid in a first-frame image, the predicted value comprises a predicted position of the insect centroid in the first-frame image, and the video comprises multiple frames of images.

13. The apparatus for analyzing insect feeding behaviors according to claim 12, wherein the step of obtaining the insect trajectories according to the predicted value comprises:
obtaining a Euclidean distance between a position of an insect centroid in a second-frame image and the predicted value, according to the predicted value and the position of the insect centroid in the second-frame image; and
determining a trajectory of each of the insects by using a Hungarian algorithm according to the Euclidean distance,
wherein, the detection result comprises the position of the insect centroid in the second-frame image, and the second frame is larger than the first frame.

14. The method for analyzing insect feeding behaviors according to claim 8, wherein the step of obtaining an analysis result according to the insect trajectories comprises:
obtaining a trajectory chart of insect paths, and/or frequencies of the paths, and/or aggregations of insects when feeding, according to the insect trajectories.

15. A storage medium, storing a set of processor executable instructions, when executed by a processor, causing the processor to perform a method for analyzing insect feeding behaviors, the method comprising:
obtaining a video recording feeding activities of a plurality of insets;
detecting the insects in the video by deep learning using a neural network, to obtain a detection result;
obtaining trajectories of the insects according to the detection result; and
obtaining an analysis result according to the trajectories of the insects.

16. The storage medium according to claim 15, wherein the video comprises multiple frames of image, and the step of detecting insects in the video by deep learning using a neural network comprises:
labeling the insects by using a ground truth box in images; and
inputting the labeled images into the neural network for deep learning, and obtaining a detection result according to a preset threshold.

17. The storage medium according to claim 16, wherein the step of inputting the labeled images into the neural network for deep learning, and obtaining a detection result according to a preset threshold comprises:
dividing the labeled images into multiple grids through the neural network;
obtaining prediction information by deep learning according to a relationship between the center position of the ground truth box and the position of the grids; and
obtaining the detection result according to the preset threshold and a confidence score,
wherein, the prediction information comprises multiple pieces of bounding box information and corresponding confidence scores predicted by each grid and class information predicted by each grid, and the bounding box information comprises an offset of the center position of the ground truth box relative to the position of the grids, a width and a height of the ground truth box; and
the detection result comprises at least part of the prediction information.

18. The storage medium according to claim 17, wherein the step of obtaining the detection result according to the preset threshold and a confidence score comprises:
filtering the bounding box information of which the confidence score is less than the preset threshold; and
processing the bounding box information retained after filtering, by non-maximum suppression, to obtain the detection result.

19. The storage medium according to claim 15, wherein the step of obtaining insect trajectories according to a detection result comprises:
processing the detection result by Kalman filtering to obtain a predicted value of an insect position; and
obtaining the insect trajectory according to the predicted value,
wherein, the detection result comprises a position of an insect centroid in a first-frame image, the predicted value comprises a predicted position of the insect centroid in the first-frame image, and the video comprises multiple frames of images.

20. The storage medium according to claim 19, wherein the step of obtaining the insect trajectories according to the predicted value comprises:
obtaining a Euclidean distance between a position of an insect centroid in a second-frame image and the predicted value, according to the predicted value and the position of the insect centroid in the second-frame image; and
determining a trajectory of each of the insects by using a Hungarian algorithm according to the Euclidean distance,
wherein, the detection result comprises the position of the insect centroid in the second-frame image, and the second frame is larger than the first frame.
